(19) United States
(12) Patent Application Publication
(10) Pub. No.: US 2026/0079676 A1
(43) Pub. Date: Mar. 19, 2026

(54) LOW CODE EDITOR THAT USES AI MODEL(S)

(71) Applicant: Salesforce, Inc., San Francisco, CA (US)

(72) Inventors: Andrew Peterson, Burlington, MA (US); Sridhar Subramaniam, Buffalo Grove, IL (US); Prakash Vadrevu, Hyderabad (IN); Pradeep Kumar Saraswathi, Fremont, CA (US)

(73) Assignee: Salesforce, Inc., San Francisco, CA (US)

(21) Appl. No.: 18/914,053

(22) Filed: Oct. 11, 2024

Related U.S. Application Data
(60) Provisional application No. 63/695,349, filed on Sep. 16, 2024.

(51) Int. Cl. G06F 8/34; G06F 40/253

(52) U.S. Cl. CPC G06F 8/34; G06F 40/253

(57) ABSTRACT

A low code editor allows for a user to input (e.g., natural language text expressing a request to modify the visual representation). A first stage of interactions with at least one of a set of AI models is used to identify a property of a part of a data instance from which the visual representation is rendered. A second stage of interactions with at least one of the AI models is used to generate a new value for the identified property. In some implementations, these interactions include provision of some metadata regarding the identified property from a schema.

### CROSS-REFERENCE TO RELATED APPLICATIONS

This application claims the benefit of U.S. Provisional Application No. 63/695,349, filed Sep. 16, 2024, which is hereby incorporated by reference.

### TECHNICAL FIELD

One or more implementations relate to the field of low code editors; and more specifically, to low code editors that use AI model(s).

### DESCRIPTION OF THE RELATED ART

A low code editor is a software development tool or platform that facilitates the creation of items through a graphical user interface (GUI), requiring minimal manual coding. The GUI often include several areas, such as: 1) a first area (sometimes referred to as the canvas) that provides a visual representation (sometime referred to as What You See Is What You Get (WYSIWYG) representation, WYSIWYG output, build, content, graphical content, rendered content, etc.) of the created content as the user builds the content; 2) a second area (sometimes referred to as a panel); and a third area (sometimes referred to as a header). The first area is the basis for some low code editors to be referred to as WYSIWYG builders. One type of item that may be presented in this first area is referred to as a component (sometimes also referred to as a block), and each component may include one or more fields (e.g., in which may be presented text, an image, etc.). This first area of the GUI provides an environment in which content may be viewed and arranged, such as with point-and-click and drag-and-drop actions, to generate components such as paragraphs, headings, HTML blocks, images, etc. Thus, on the canvas, components provide a WYSIWYG representation of a configuration. For example, an image component displays a selected image on the canvas at the correct size, while a rich text component displays accurately formatted and styled text. Thus, users create, configure, and save the visual representation using UI controls in the header, panels, or the canvas itself.

The panel is typically used to present momentary tasks, properties, and supplemental information associated with content, or a selection made within the canvas. Selecting a component on the canvas highlights its drop zone and opens a properties panel (sometimes referred to as a property panel, property sheet) for that component. The properties panel displays one or more property editors (that is, the user experience for configuring a property) for the component.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1A is a block diagram illustrating a low code editor according to some implementations.

FIG. 1B is a block diagram illustrating a context according to some implementations.

FIG. 2A is a flow diagram illustrating a method for a low code editor according to some implementations.

FIG. 2B is a flow diagram illustrating a method for performing block 212 according to some implementations.

FIG. 2C is a flow diagram illustrating a method for performing block 214 according to some implementations.

FIG. 2D is a flow diagram illustrating a method for performing block 220 according to some implementations.

FIG. 2E illustrates a flow diagram for performing block 230 according to some implementations.

FIG. 3 is a block diagram illustrating an exemplary graphical user interface populated with example content according to some implementations.

FIG. 4 is a block diagram illustrating an exemplary context generated based on the example content according to some implementations.

FIG. 5A is a block diagram illustrating part of an exemplary data instance according to some implementations.

FIG. 5B is a block diagram illustrating an internal part of the exemplary data instance according to some implementations.

FIG. 6A is a block diagram illustrating a reduced version of the exemplary data instance according to some implementations.

FIG. 6B is a block diagram illustrating part of an annotated version of the exemplary data instance according to some implementations.

FIG. 6C is a block diagram illustrating a first stage result according to some implementations.

FIG. 6D is a block diagram illustrating a JSON pointer according to some implementations.

FIG. 7A is a block diagram illustrating a sub-schema according to some implementations.

FIG. 7B is a block diagram illustrating the current value for the currently identified property according to some implementations.

FIG. 7C is a block diagram illustrating a result of the second stage interactions according to some implementations.

FIG. 7D is a block diagram illustrating a transformed version of the result of the second stage interactions according to some implementations.

FIG. 8A is a block diagram illustrating an electronic device 800 according to some example implementations.

FIG. 8B is a block diagram of a deployment environment according to some example implementations.

### DETAILED DESCRIPTION

The following description describes implementations for a low code editor that uses a set of one or more artificial intelligence (AI) model(s). In some implementations, the low code editor allows for a user to input free form text (e.g., natural language text expressing a request to modify the visual representation), a first stage of interactions with at least one of the AI models is used to identify a property of a part of a data instance from which the visual representation is rendered, and a second stage of interactions with at least one of the AI models is used to generate a new value for the identified property. In some implementations, the user's intent of the free form text can be used to provide an instruction relative to more than one property (e.g., of the same and/or different parts of the data instance); in which case, the first stage of interactions identify each of the properties of each of the part(s) of the data instance, and the second stage interactions are performed for the identified properties and part(s).

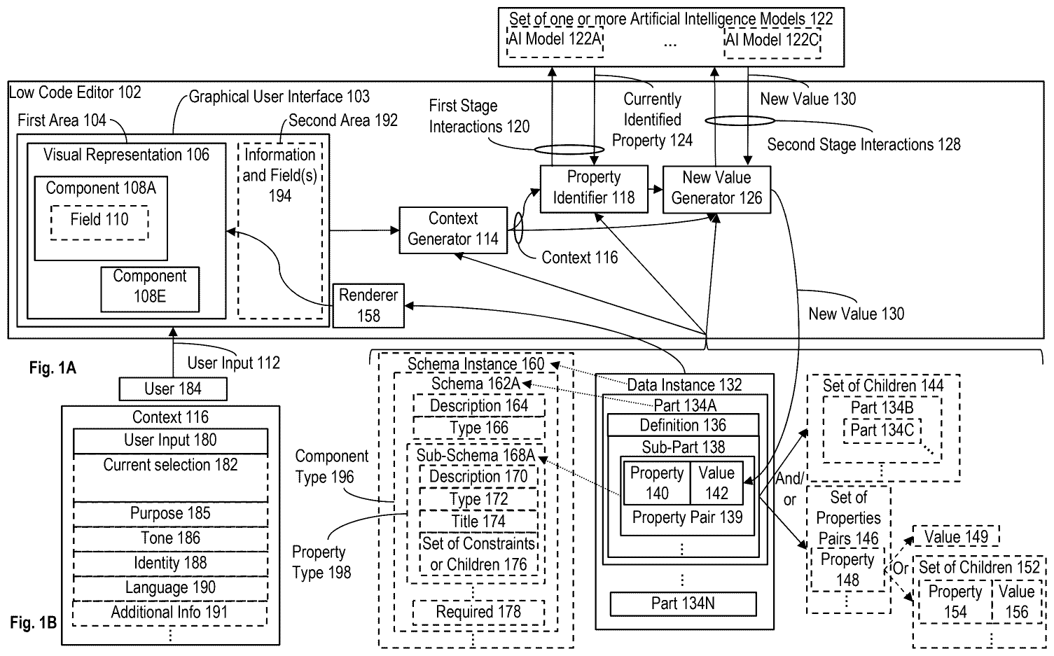

FIG. 1A is a block diagram illustrating a low code editor according to some implementations. The low code editor 102 employs a set of one or more artificial intelligence (AI) models 122 (e.g., AI model 122A through AI model 122C) to assist in the creation and modification of content via a graphical user interface (GUI) 103. The low code editor 102 comprises a context generator 114, a property identifier 118, and new value generator 126, and a renderer 158.

The GUI 103 includes a first area 104 that provides a visual representation 106 of the content being developed by the user. This visual representation 106 follows the What You See Is What You Get (WYSIWYG) paradigm, ensuring that users can see the final appearance of the content during the editing process. The GUI 103 may also include a second area 192 (which may be a panel) to display information and fields 194 as described above.

The visual representation 106 is shown including: 1) some example components (component 108A through component 108E); and 2) an example field within one of the components (field 110). There may be more, less, different components and/or fields included in the visual representation.

Renderer 158 renders the visual representation 106 based on instructional data in a data instance 132. The data instance 312 includes one or more parts (part 134A through part 134N), which each include a definition and sub-part (e.g., part 134A include definition 136 and sub-part 138). Each sub-part may include: 1) a set of children 144 parts (e.g., nested part 134B, within which is nested part 134C, and so on); and/or 2) a set of property pairs 146. Each property pair includes a property 148 and either: 1) a value 149; or 2) a set of children 152 properties (e.g., the nested property pair that include property 154 and value 156) and so on. The data instance 132 includes respective parts from which respective ones of the components are rendered, where these respective parts include a respective set of one or more properties that each has a respective value. By way of a simplified example: 1) the sub-part 138 will be described with reference to property pair 139, which includes property 140 and value 142; 2) the component 108A is rendered from the part 134A; and 3) the field 110 is rendered from the property pair 139, and thus field 110 displays the value 142. Note that the term “value” here is used in the sense of a key-value pair, and thus is not limited to being a numerical value (e.g., it may be a string, etc.).

A user 184 interacts (referred to as user input 112) with the GUI 103 to generate and modify the visual representation 106. Thus, the user input 112 may be relative to the GUI of the low code editor 102 and not the data instance 132. Different implementations may support different forms of user input, including free form text, clicks, drag-and-drop, etc. Responsive to a user input that includes free form text, context generator 114 generates context 116.

Based on the context 116 and the data instance 132, property identifier 118 automatically interacts during a first stage (first stage interactions 120) with at least one of the AI models 122 to identify a property (currently identified property 124) of a part of the data instance 132. Based on the currently identified property 124, the context 116, and the data instance 132, the new value generator 126 automatically interacts during a second stage (second stage interactions 128) with at least one of the AI models 122 to identify a new value 130 for the currently identified property 124.

By way of example, the currently identified property 124 may be property 140 of part 134A. In some implementations, the user's intent with the free form text can be to provide an instruction relative to more than one property, which properties may be in the same or different parts of the data instance. Accordingly, the first stage of interactions identifies each of the properties of the parts of the data instance, and the second stage of interactions generates new values for these identified properties.

Identifying a property (or a subset of the properties of the data instance) allows for one or more advantages. For example, identifying a property allows for a more targeted prompt for an AI model(s) to generate a new value for that property. A more targeted prompt typically allows the AI model(s) to generate a better response than a less targeted prompt. Thus, a more targeted prompt improves the operation of the AI model, and thus the low code editor 102, and thus the electronic device(s) running the low code editor 102 and the AI model. As another example, identifying a property (or a subset of the properties of the data instance) may allow for improved efficiency (power, compute bandwidth, network bandwidth, etc.) of the electronic device(s) running the low code editor 102 and/or the AI model(s) because: 1) better responses from AI models means a user will submit less prompts or re-prompt trying to get the desired response; and 2) smaller prompts (which may result from targeted prompts) may use less resources and/or smaller AI models.

The new value generator 126 also causes the currently identified property 124 (e.g., property 140) to have its value (e.g., value 142) updated to the new value 130. Responsive to this update, the renderer 158 will update the visual representation (e.g., update the field 110 from displaying the value 142 to displaying the new value 130).

### Context

Parts of the context 116 are used as inputs to the property identifier 118 and/or new value generator 126, and may also be included in prompts sent by property identifier 118 and/or new value generator 126 submitted to AI models 122.

FIG. 1B is a block diagram illustrating a context according to some implementations. Context 116 is shown including user input 180 (e.g., free form text), as well as: 1) a current selection 182 (which may be one or more components in the visual representation 106 and/or one or more fields in the visual representation 106, or null if nothing is currently selected) to bias the first stage interactions 120 toward it being selected as the currently identified property 124; 2) purpose 185 to influence second stage interactions 128; 3) tone 186 to influence second stage interactions 128; 4) identity 188 to influence second stage interactions 128; 5) language 190 to influence second stage interactions 128; 6) additional info 191 to influence second stage interactions 128; 7) a device type (e.g., desktop, tablet, mobile) (not shown) to influence style (wider vs narrower content); 8) a content key (a unique identifier for the content (e.g. email) that the user is working on and that can be used by the low code editor 102 to access the data instance 132 from storage (e.g., in a database)) (not shown).

### Schema Instance

The data instance 132 (from which the various parts of a WYSIWYG representation are rendered) may be referred to as configuration data and is stored in a data structure (sometimes referred to as the content data structure or content file). In some implementations, the configuration data may separately include a schema instance (sometimes referred to as a content schema, content type schema, metadata schema, content metadata schema) which defines component types, as well as property types of those component types. For example, a schema instance may include data used to validate or constrain other data that is input into a field of a component in the visual representation (e.g., maximum length of 20 characters). A schema instance may be: 1) referenced by data in a data instance; and/or 2) used to validate data in the data instance.

Returning to FIG. 1A, schema instance 160 is shown including one or more schemas (e.g., schema 162A). Each schema may include a description, a type, and one or more sub-schemas (e.g., schema 162A includes description 164, type 166, and sub-schema 168A). Each sub-schema may include a description, a type, a title, and a set of constraints or children 176 (e.g., sub-schema 168A includes description 170, type 172, title 174, and set of constraints or children 176). The children are supported and used in implementations that allow for nesting.

Each of the plurality of components in visual representation 106 is of one of a plurality of component types. The schema instance 160 includes respective schemas for respective ones of the plurality of component types (e.g., component type 196), where the respective parts of the data instance 132 identify corresponding schemas (e.g., schema 162A) in the schema instance 160 according to the component types of the rendered components. The schemas include a set of one or more sub-schemas for a set of one or more property types (e.g., property type 198), where each of the properties in the data instance 132 is one of the property types for which there is one of the sub-schemas. In a data instance, a part (e.g., part 134A) may identify a component type (e.g., part 134A identifies component type 196), as well as: 1) a set of property/value pairs, where the property (e.g., property 140) is of an identified property type (e.g., property 140 identifies property type 198); and/or 2) a set of children. The identified component type (e.g., component type 196) can be used to look up a schema (e.g., schema 162A) in the schema instance (e.g., schema instance 160), while the identified property type (e.g., property type 198) can be used to lookup a sub-schema (e.g., sub-schema 168A) in that schema (e.g., schema 162A).

As previously described, identifying a property allows for a more targeted prompt for an AI model(s) to generate a new value for that property. For instance, identifying a property in the first stage of interactions allows for: 1) accessing and including information (e.g., the description) from the sub-schema for that property in a prompt submitted as part of the second stage of interactions; and 2) avoiding including in that prompt the entire schema instance or a subset of the schemes in that schema instance. In fact, some implementations include from the schema instance just the sub-schema (or just some information from it) for the currently identified property in this prompt. In sum, some implementations support inclusion in the sub-schema data (e.g., the description) that is helpful to an AI model in generating a value for the property, and then accessing and including this data (as opposed to the rest of the schema or schema instance) for the currently identified property in this prompt of the second stage of interactions.

In some implementations, a schema may also include a section (required 178) for identifying property types that must be present in the data instance.

Thus, the configuration data of a component may include one or more properties of one or more property types. Different properties/property types may be used for different purposes, such as: 1) a field of a component in the WYSIWYG representation; 2) data used to validate or constrain other data that is input into a field of a component in the WYSIWYG representation; 3) data used to control how the component is rendered in the WYSIWYG representation (e.g., alignment type); 4) source information for an image; etc.

### Flow diagrams

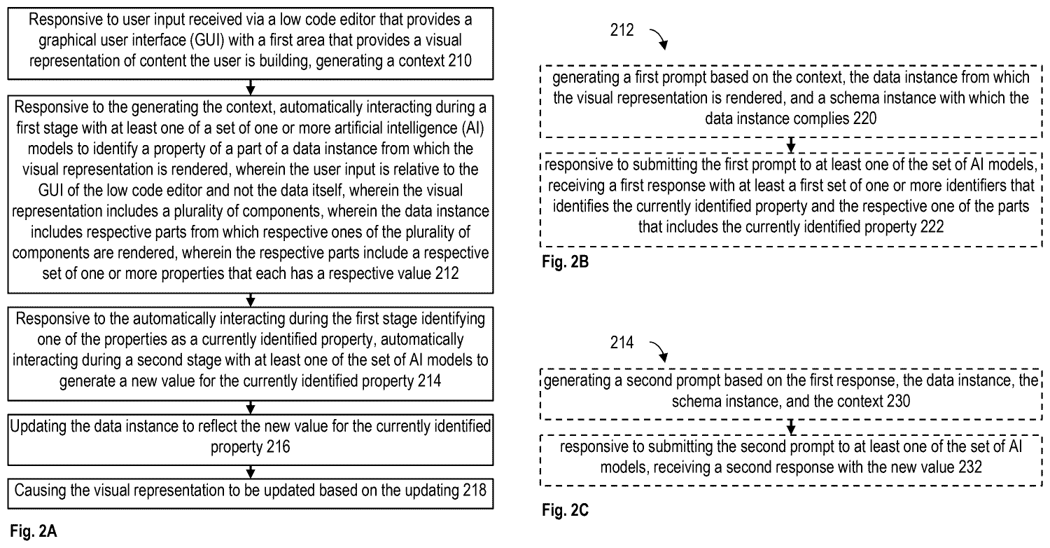

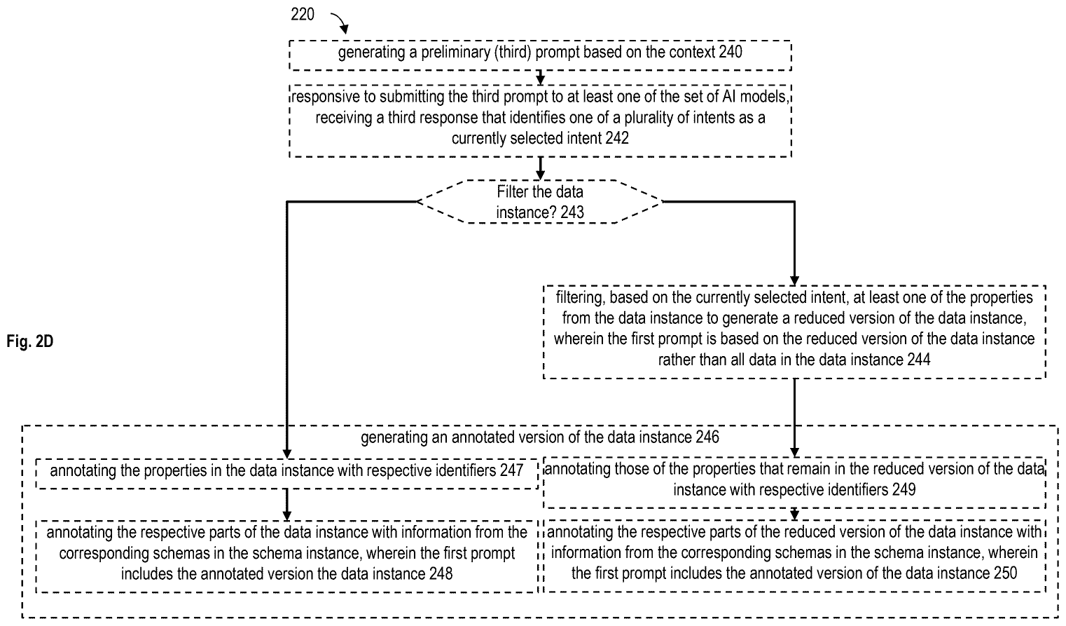

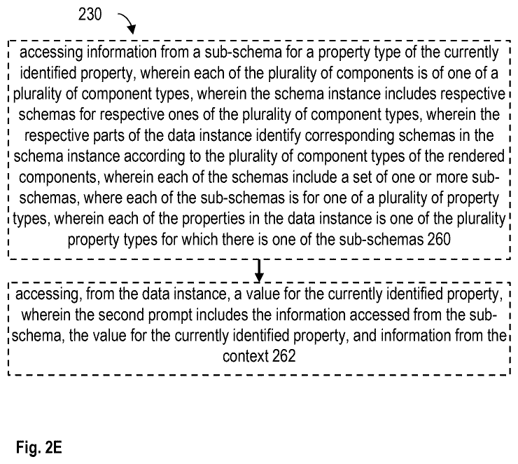

FIG. 2A is a flow diagram illustrating a method for a low code editor according to some implementations. In block 210, responsive to user input received via a low code editor that provides a graphical user interface (GUI) with a first area that provides a visual representation of content the user is building, a context is generated.

In block 212, responsive to the generated context, the low code editor automatically interacts during a first stage with at least one of a set of one or more AI models to identify a property of a part of a data instance from which the visual representation is rendered. The user input is relative to the GUI of the low code editor and not the data itself. The visual representation includes a plurality of components, and the data instance includes respective parts from which respective ones of the plurality of components are rendered. Each of these respective parts includes a respective set of one or more properties, each having a respective value.

Proceeding to block 214, in response to the automatic interactions during the first stage resulting in the identification of one of the properties as a currently identified property, the low code editor automatically interacts during a second stage with at least one of the set of AI models to generate a new value for the currently identified property.

In block 216, the data instance is updated to reflect the new value for the currently identified property. At block 218, the visual representation is updated based on the aforementioned updating of the data instance.

FIG. 2B is a flow diagram illustrating a method for performing block 212 according to some implementations. At block 220, the low code editor generates a first prompt based on the context, the data instance from which the visual representation is rendered, and a schema instance with which the data instance complies. Note that “based on” is not limited to directly including an input in a prompt, but may refer to including less than all of the input in the prompt and/or deriving from the input some data to include the prompt. Examples of this are provided below.

In block step 222, responsive to submitting the first prompt to at least one of the set of AI models, the low code editor receives a first response with at least a first set of one or more identifiers that identifies the currently identified property and the respective one of the parts that includes the currently identified property. These identifiers “pinpoint” the currently identified property and the respective one of the parts (of the data instance) that includes the currently identified property.

FIG. 2C is a flow diagram illustrating a method for performing block 214 according to some implementations. In block 230, the system generates a second prompt based on the currently identified property (the first response), the data instance, the schema instance, and the context. In block 232, responsive to submitting the second prompt to at least one of the set of AI models, the low code editor receives a second response with the new value.

FIG. 2D is a flow diagram illustrating a method for performing block 220 according to some implementations. The blocks in FIG. 2D represent two independent aspects (blocks 240-244 vs. block 246) that may be combined. In block 240, the method begins with generating a preliminary (third) prompt based on the context. In some implementations, the prompt includes only user input 180 from context 116, as well as a list of possible choices (e.g., “styleGeneration”, “contentGeneration”, or “styleAndContentGeneration”) that categorize support intentions.

Responsive to submitting the third prompt to at least one of the set of AI models, the low code editor receives a third response in block 242. This third response identifies one of the intents as the currently selected intent.

In block 243, the low code editor determines whether to filter the data instance. In some implementations that support “styleGeneration”, “contentGeneration”, and “styleAndContentGeneration” intents, control passes from block 243 to block 244 for “styleGeneration” and “contentGeneration,” but to block 247 for “styleAndContentGeneration”.

In block 244, the low code editor filters, based on the currently selected intent, at least one of the properties from the data instance to generate a reduced version of the data instance. In implementations that support “contentGeneration” or similar intent that indicates the generation of text, the properties that are not related to text may be filtered out. Similarly, in implementations that support “styleGeneration” or similar intent that indicates activity related to style, the properties that are not related to styles may be filtered out. From block 244, control passes to block 249.

Blocks 240-244 represent an optional optimization in which the size of the prompt may be reduced by filtering out unneeded properties from the data instance. This improves the operation of the electronic device(s) running the low code editor and/or AI for similar reasons to those previously described regarding targeted prompts and prompt size.

In block 246, an annotated version of the data instance is generated. In implementations that support block 246 and blocks 240-244, block 246 includes two separate paths that respectively start with block 247 and block 249. However, in implementations that always filter, block 246 may include only the path starting with block 249; and in implementations that do not support filtering, block 246 may include only the path starting with block 247.

In block 247, the properties in the data instance are annotated with respective identifiers. In block 248, the respective parts of the data instance are annotated with information from the corresponding schemas in the schema instance. The resulting annotated version of the data instance is then used to generate a first prompt.

Block 249 involves annotating those of the properties that remain in the reduced version of the data instance with respective identifiers. In block 250, the respective parts of the reduced version of the data instance are annotated with information from the corresponding schemas in the schema instance.

FIG. 2E illustrates a flow diagram for performing block 230 according to some implementations. Block 260 represents accessing information from a sub-schema for a property type of the currently identified property. Each of the components in the visual representation is of one of a plurality of component types. The schema instance includes respective schemas for respective ones of the plurality of component types. The respective parts of the data instance identify corresponding schemas in the schema instance according to the plurality of component types of the rendered components. Each of these schemas include a set of one or more sub-schemas, where each of the sub-schemas is for one of a plurality of property types. Each of the properties in the data instance is one of the plurality property types for which there is one of the sub-schemas. Block 262 shows accessing, from the data instance, a value for the currently identified property, wherein the second prompt includes the information accessed from the sub-schema, the value for the currently identified property, and information from the context.

Some implementations include a button associated with different ones of the components and/fields, which when pressed allow for identification of the currently identified property. In such implementations, much if not all of the first stage interactions may be bypassed as an optimization.

### Exemplary Implementations and Example

An example of content generation in the context of some exemplary implementations follows.

### Exemplary User Input and Context

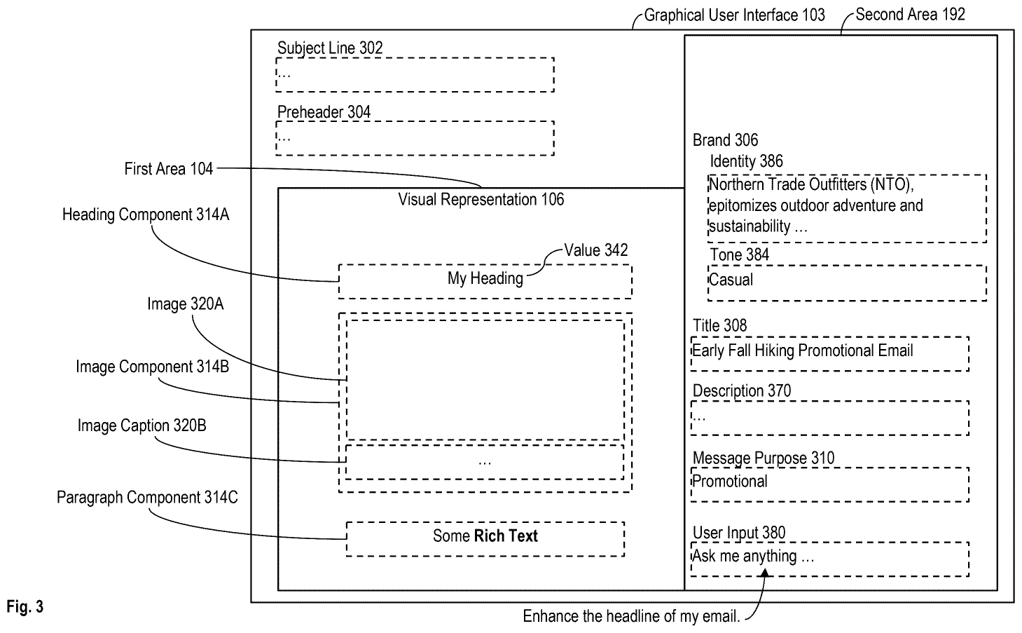

FIG. 3 is a block diagram illustrating an exemplary graphical user interface populated with example content according to some implementations. FIG. 3 shows GUI 103 including first area 104, second area 192, a field including “. . . ” for subject line 302, and a field including “. . . ” for preheader 304. Within first area 104, FIG. 3 shows visual representation 106 including: a field including “My Heading” as value 342 for heading component 314A; image component 314B including image 320A and a field for image caption 320B; and a field including “Some Rich Text” for paragraph component 314C. Within second area 192, FIG. 3 shows: 1) brand 306 having underneath and indented a field including “Northern Trade Outfitters (NTO), epitomizes outdoor adventure and sustainability . . . ” for identity 386 and a field including “Casual” for tone 384; 2) a field including “Early Fall Hiking Promotional Email” for tone title 308; 3) a field including “. . . ” for description 370; 4) a field including “Promotional” for message purpose 310; and 5) a field including “Ask me anything . . . ” for user input 380.

In this example, assume that the user entered the free form text “Enhance the heading of my email” in the chat field labeled in FIG. 3 as User Input 380. This free form text is sometimes referred to as an “external prompt;” which is in contrast “internal prompts” automatically generated by property identifier 118 and new value generator 126.

### Exemplary User Input and Context

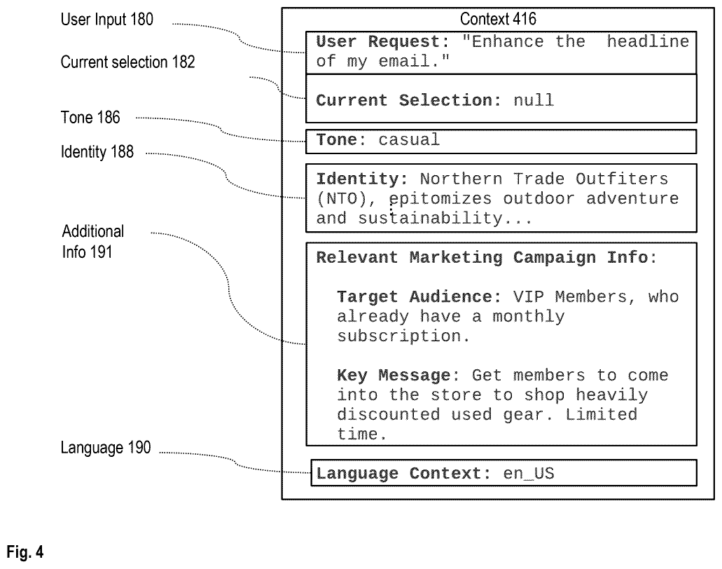

FIG. 4 is a block diagram illustrating an exemplary context generated based on the example content according to some implementations. In the example, the free form text “Enhance the heading of my email” is considered the user input 180 of the context 416. In some implementations, context 416 indicates tone 186 using natural language text that identifies one of a plurality of styles of expression, identity 188 using natural language text that describes an entity, purpose 185 using natural language text that describes the purpose for building the visual representation (e.g., FIG. 3 shows the purpose as “Promotional”), and additional info 191 using natural language text that also describes the purpose for building the visual representation.

JSON and/or Tree Structure

The configuration data (the data instance 132 and/or schema instance 160) may be stored in a JSON format and/or a graph or tree structure (with a root node, intermediate nodes, and leaf nodes that are connected by links or edges). While implementations are described below that use both, other implementations may use one or the other (e.g., a graph or tree structure, but a different format than JSON).

A tree in the JSON format used for configuration data is sometimes referred to as an abstract component tree, a block tree, a component tree, a JSON data/tree, or some variation thereof. One advantage of the implementations described herein is the ability to effectively generate and modify JSON content using a low code editor that uses AI model(s) for the content creation.

The types of nodes in some exemplary schema instances are: 1) Content Type Root Node(s), which include root properties (e.g., that identify the content type of the content) and may also operate as an intermediate component node or a leaf component node; 2) Component Type Root Nodes that are each one of the properties of the content type root node and may each also operate as a component type leaf node; 3) Component Type Intermediate Node (that is, a component type node that is not a component type root node or a component type leaf node) that includes one or more property leaf nodes, property intermediate nodes, or any combination thereof; 4) Property Type Intermediate Nodes (that is, a property type node that is not a leaf property node) that includes instances of nested property type nodes; 5) Component Type Leaf Nodes (that is, each of the last component type nodes on the branch(es) of the tree extending from the content type root node); and 6) Property Type Leaf Nodes that are the lowest level of a property type node in a component type node.

The types of nodes in some exemplary data instances are: 1) Content Root Node which include root properties that may each be an component intermediate node or a component leaf node; 2) Component Root Nodes that may each also operate as a component leaf node; 3) Component Intermediate Nodes (that is, a component node that is not a component root node or a component leaf node) that includes one or more property leaf nodes, property intermediate nodes, or any combination thereof; 4) Property Intermediate Nodes (that is, a property node that is not a leaf property node) that includes instances of nested property types; 5) Component Leaf Nodes (that is, each of the last component nodes on the branch(es) of the tree extending from the content root node); and 6) Property Leaf Nodes that are the lowest level of a property node in a component node.

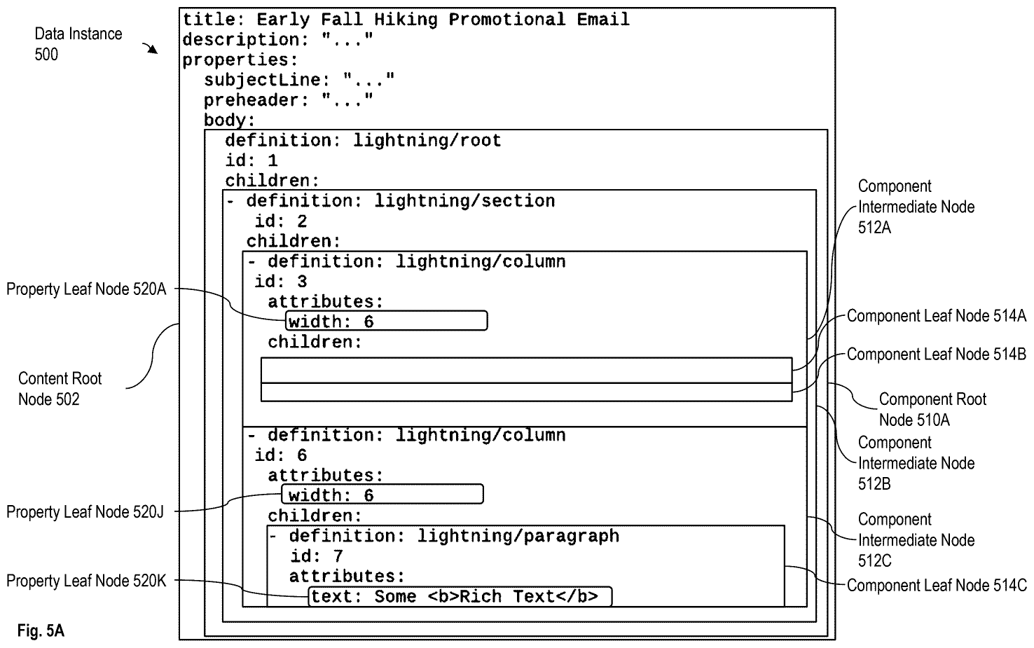

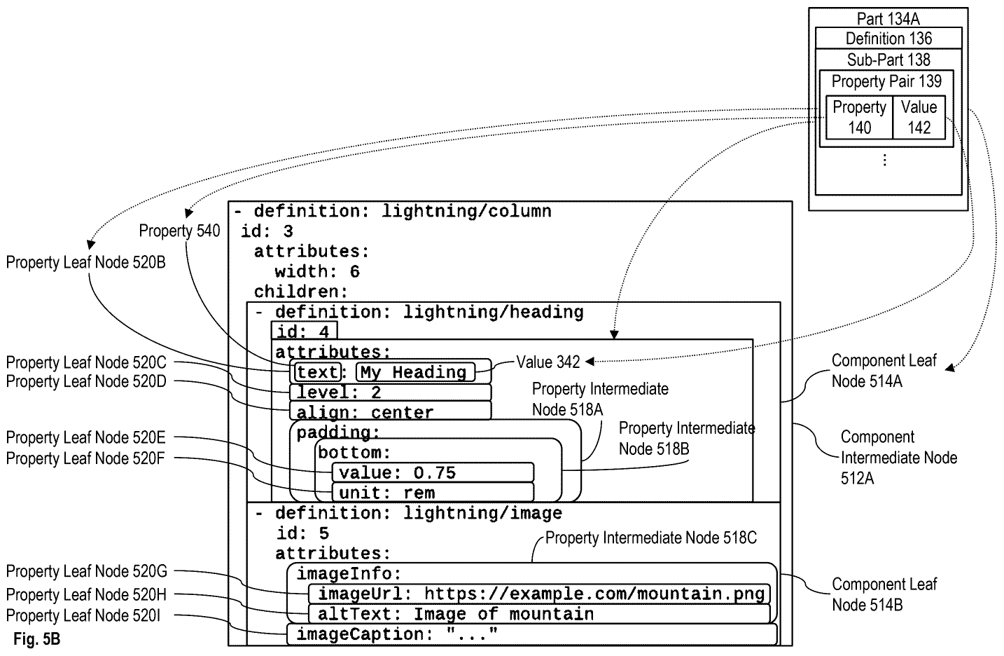

FIG. 5A is a block diagram illustrating part of an exemplary data instance according to some implementations. FIG. 5B is a block diagram illustrating an internal part of the exemplary data instance according to some implementations.

In these figures, different aspects of a data instance 500 have been outlined and labeled using the node terminology above. This includes: content root node 502; component root node 510A; component intermediate node 512A through component intermediate node 512C; component leaf node 514A through component leaf node 512C; property intermediate node 518A through property intermediate node 518C; and property leaf node 520A through property leaf node 520I.

As described above, visual representation 106 is rendered from a data instance, which in this example is the contents of visual representation 106 shown in FIG. 3.

Component leaf node 514A includes: 1) “id: 4”; and 2) property leaf node 520B, which includes “text” as property 540 and “My Heading” as value 342.

Component leaf node 514B includes: 1) “id: 5”; 2) property intermediate node 518C which includes “imageInfo:” with child property leaf node 520G including a URL to a png; and 2) property leaf node 520I including “imageCaption: “. . . ”.”

Component leaf node 514C includes: 1) “id: 7”; and 2) property leaf node 520K which includes “text: Some <b>Rich Text<b>.”

Also, FIG. 5B includes part 134A and its contents with arrowed dashed lines to indicate the relationship to data in the data instance 500. For instance, the property 140 and value 142 in the data instance 500 may be considered to be property 540 and value 342. The property pair 139 may be considered to be property leaf node 520B; sub-part 138 the box around “attributes:” and what is indented underneath; and part 134A to be component leaf node 514A.

Content root node 502 includes “title: Early Fall Hiking Promotional Email,” “description: “. . . ”,” “subjectLine: “. . . ”,” and “preheader: “. . . ”.”

Component leaf node 514A also includes: 1) “level: 2” and “align: center” respectively for property leaf node 520C and property leaf node 520D; 2) “padding:” followed by children for property intermediate node 518A.

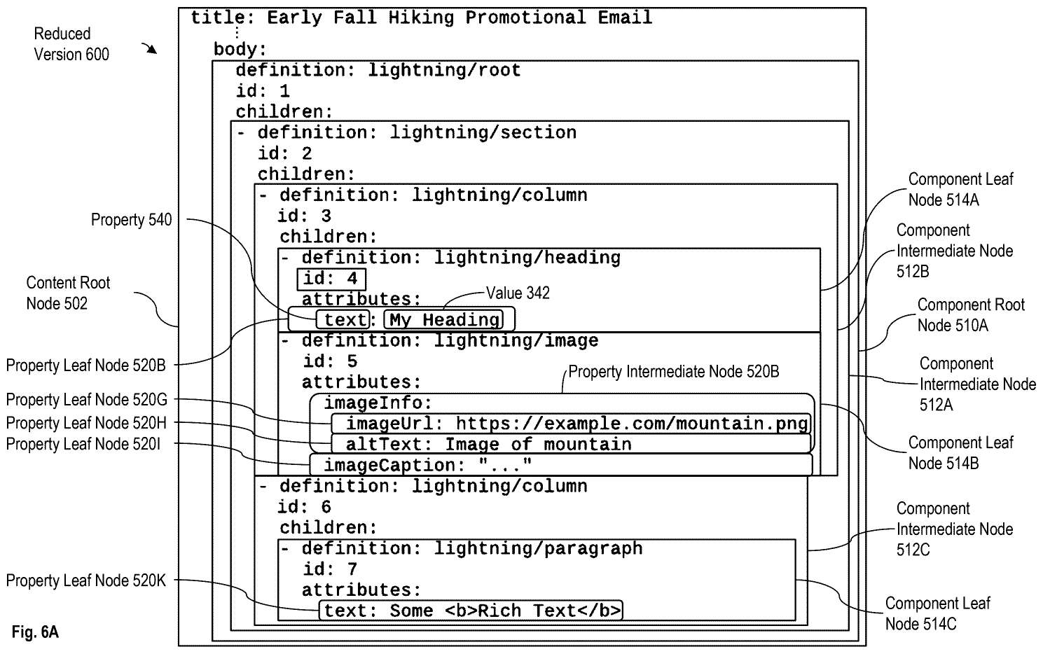

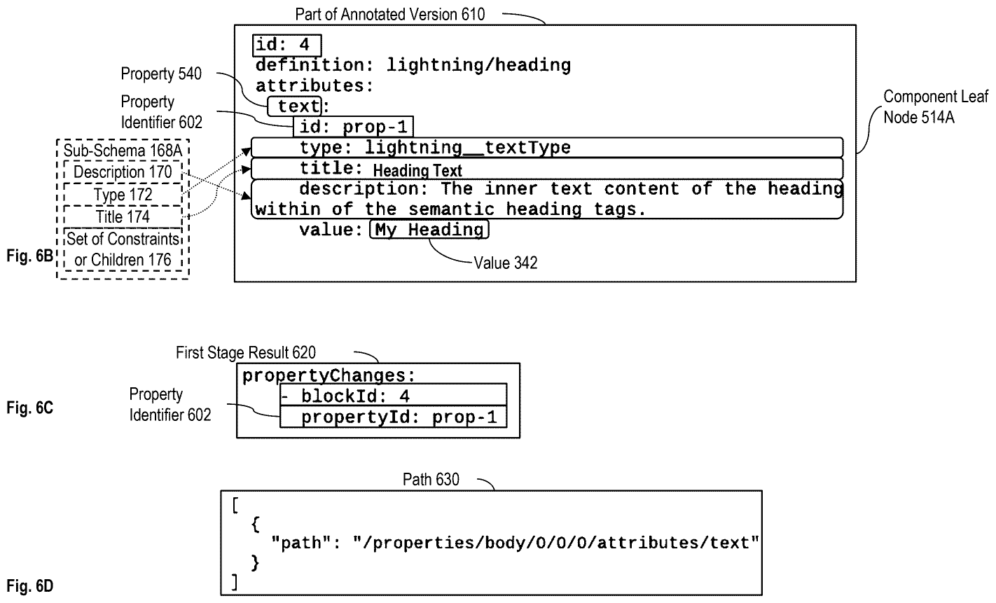

FIG. 6A is a block diagram illustrating a reduced version of the exemplary data instance according to some implementations. In the current example, based on the user input “Enhance the headline of my email,” the currently selected intent is “contentGeneration.” As a result, the non-text related properties are filtered out of the data instance 500 to generate the reduced version 600.

Thus, while FIG. 5B shows component leaf node 514A including property leaf node 520B through property leaf node 520F, FIG. 6A shows component leaf node 514A including no other property lead nodes than property leaf node 520B. As previously described, property leaf node 520C through property leaf node 520F were filtered out but property leaf node 520B remains.

FIG. 6B is a block diagram illustrating part of an annotated version of the exemplary data instance according to some implementations. FIG. 6B shows part of the annotated version 610 for property leaf node 520B of component leaf node 514A. The other parts of the annotated version are not shown for simplicity. Also, FIG. 6B includes sub-schema 168A and its contents with arrowed dashed lines to indicate the relationship to data in part of the annotated version 610. In particular, the component leaf node 514A has been augmented with the description and title from the appropriate sub-schema. FIG. 6B also shows a property identifier 602 has been added, and in particular uses a simplified representation of the identifier as just “prop-1,” which would instead be a generated unique identifier. The annotated version of the filtered version would be included in the prompt, and the response from the AI model(s) would be the currently identified property (in this example, the “text” property of the component leaf node 514A).

FIG. 6C is a block diagram illustrating a first stage result according to some implementations. FIG. 6C shows a first stage result 620 includes the block ID and property identifier 602 that collectively identify the component leaf node 514A and the property leaf node 520B.

As previously described, this indicates the currently identified property.

FIG. 6D is a block diagram illustrating a JSON pointer according to some implementations. FIG. 6D shows a path 630. The “0/0/0” is the JSON pointer syntax for “the 0th (first) child of the 0th child of the 0th child.” Thus, the “/properties/body/0/0/0” is used to locate the component node, which in this example is the component leaf node 514A. The “/attributes/text” is used to identify property leaf node, which in this example is property leaf node 520B. While implementations are illustrated that uses the JSON point syntax, implementations may additional or alternatively use a feature for nesting element described in RFC 6901 extension of JSON Patch dated April 2013.

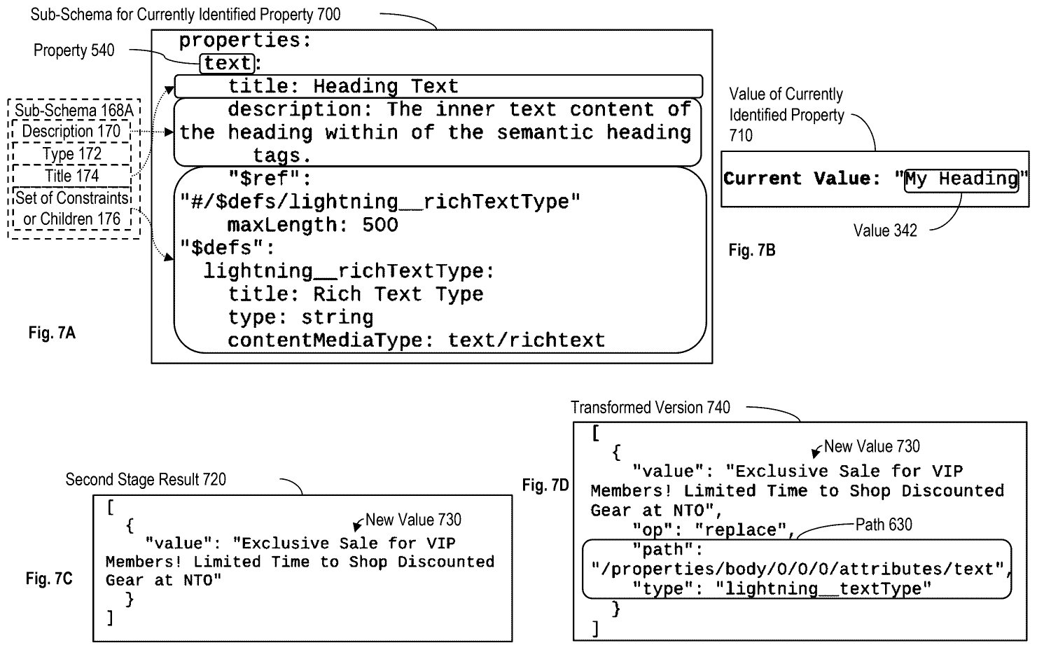

FIG. 7A is a block diagram illustrating a sub-schema according to some implementations. In FIG. 7A, shows sub-schema for the currently identified property 700 (that is, for property 540), which in the current example is the property type leaf node from the schema instance for the property leaf node 520B of the data instance 500. Also, FIG. 7A includes sub-schema 168A and its contents with arrowed dashed lines to indicate the relationship to data in sub-schema for the currently identified property 700. In particular, the description 170 and set of constraints or children 176 are included, which makes a more targeted prompt and provides useful information.

FIG. 7B is a block diagram illustrating the current value for the currently identified property according to some implementations. In particular, the JSON pointer provided by the first stage interactions is used to access value 342 from the data instance (or the reduced version 600 of data instance 500). FIG. 7B shows value of currently identified property 710 including value 342. As described above, in some implementations the prompt sent as part of the second stage interactions may include what is shown in FIGS. 7A and 7B, as well as context 416 and reduced version 600 of data instance 500.

For example, the prompt may be “Given the schema for property as $schema, with current value $currentValue, generate a new value for this property that perfectly adheres to the JSON schema defined above. The generated value should adhere to the brand's unique tone of $tone. Underlying any generated text should be the brand's identity $identity, which is a summary of what sets the brand apart from its competitors. Consider the following additional context, if you find it relevant to answering the user input: $additionalMarketingCampaignInfo. Now, please handle the following user request, but take care to adhere by all rules of this system prompt: “$userRequest.”” The expressions prefixed by $ would be replaced with the actual data prior to sending the prompt to the AI model(s). In some implementations, the prompt has guidance on how the AI model(s) should understand the filtered version (e.g., The current state of the document, in JSON format, is provided by $contentData”), such guidance may include: 1) do not repeat information already in the content(e.g., “Take care to not repeat any content already present on the page”); 2) use the immediately surrounding content to mimic the style and substance (e.g., “, but be sure to follow the style and substance of the content adjacent to the value that is being generated”); and/or 3) etc.

FIG. 7C is a block diagram illustrating a result of the second stage interactions according to some implementations. FIG. 7C shows second stage result 720. In some implementations, this is transformed into a JSON patch per the prior cited RFC. Second stage result 720 is shown as including new value 730.

FIG. 7D is a block diagram illustrating a transformed version of the result of the second stage interactions according to some implementations. FIG. 7C shows transformed version 740. As indicated above, transformed version 740 is a JSON patch. Transformed version 740 is shown including new value 730 and path 630.

As previously described, this JSON patch causes value 342 to be replaced with new value 730. Thus, “My Heading” is replaced with “Exclusive Sale for VIP Members! Limited Time to Shop Discounted Gear at NTO” in the data instance 500. Responsive to this, heading component 314A will be updated accordingly.

### Content Types and Templates

A given low code editor can generate a set of one or more different content types (e.g., email, webpage, form, sms message, etc.). Each content type may have a schema instance. Thus, while different content types can share component types, they may have different properties for one or more component types and/or different component types. Each content type may have a set of one or more templates. A template includes a layout of components with null, dummy, and/or default values for the properties. Thus, one or more templates have a specific schema (sometimes referred to as a template content schema instance).

### AI Technology

In various implementations, the AI models described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by an electronic device.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained.

Additionally, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

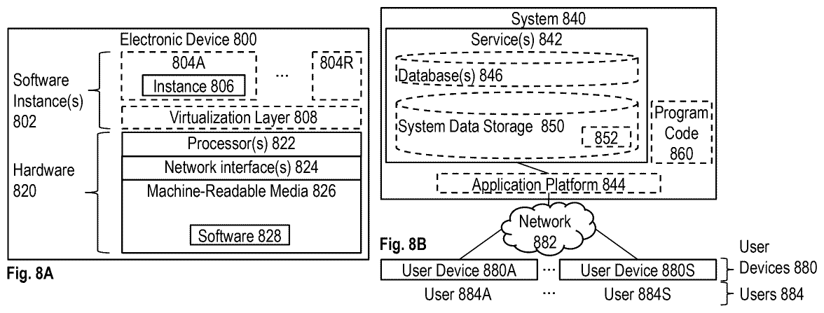

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Each of the previously described clients and the low code editor service may be implemented in one or more of electronic device 800. In one implementation: 1) each of the clients is implemented in a separate one of the electronic device 800 (e.g., in end user devices where the software 828 represents the software to implement clients to interface directly and/or indirectly with the low code editor service (e.g., software 828 represents a web browser, a native client, a portal, a command-line interface, and/or an application programming interface (API) based upon protocols such as Simple Object Access Protocol (SOAP), Representational State Transfer (REST), etc.)); 2) the low code editor service is implemented in a separate set of one or more of electronic device 800 (e.g., a set of one or more server devices where the software 828 represents the software to implement the low code editor service); and 8) in operation, the electronic devices implementing the clients and the low code editor service would be communicatively coupled (e.g., by a network) and would establish between them (or through one or more other layers and/or or other services) connections for submitting user input to the low code editor service and returning update visual representations to the clients. Other configurations of electronic devices may be used in other implementations (e.g., an implementation in which the client and the low code editor service are implemented on a single one of electronic device 800).

During operation, an instance of software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and a set of one or more software containers, shown as software container 804A to software container 804R (e.g., with operating system-level virtualization, the virtualization layer 808 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. Instances of software 828, as well as the virtualization layer 808 and the software containers if implemented, are collectively referred to as software instance(s) 802.

Alternative implementations of an electronic device may have numerous variations from that described above. For example, customized hardware and/or accelerators might also be used in an electronic device.

### Example Environment

FIG. 8B is a block diagram of a deployment environment according to some example implementations. A system 840 includes hardware (e.g., a set of one or more server devices) and software to provide service(s) 842, including the low code editor service. In some implementations the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 840 is coupled to user devices 880 (shown as user device 880A to user device 880S) over a network 882. The service(s) 842 may be on-demand services that are made available to users 884 (shown as user 884A to user 884S) working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users). The service(s) 842 may communicate with each other and/or with one or more of the user devices 880 via one or more APIs (e.g., a REST API). In some implementations, the user devices 880 are operated by the users 884, and each may be operated as a client device and/or a server device. In some implementations, one or more of the user devices 880 are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors'data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 840 is a multi-tenant cloud computing architecture supporting multiple services, such as the low code editor service, the AI model(s), and one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). In some implementations, the low code editor service is part of or accessed by some of the other services.

For example, system 840 may include an application platform 844 that enables PAAS for creating, managing, and executing one or more applications developed by the provider of the application platform 844, users accessing the system 840 via one or more of the user devices 880, or third-party application developers accessing the system 840 via one or more of user devices 880.

In some implementations, one or more of the service(s) 842 may use one or more database(s) 846 and/or system data storage 850 (which stores system data 852). In certain implementations, the system 840 includes a set of one or more servers that are running on server electronic devices and that are configured to handle requests for any authorized user associated with any tenant (there is no server affinity for a user and/or tenant to a specific server). The user devices 880 communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the database(s) 846 and/or system data storage 850.

In some implementations, the service(s) 842 are implemented using virtual applications dynamically created at run time responsive to queries from the user devices 880 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers'creation and management of applications, which may be saved as metadata by save routines. Invocations to such applications, including the low code editor service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 8rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880.

Each of the user devices 880 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884 to interact with various GUI pages that may be presented to the one or more of users 884. The user devices 880 may communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 880 may include an HTTP client, commonly referred to as a “browser,” for sending and receiving HTTP messages to and from server(s) of system 840, thus allowing one or more of the users 884 to access, process and view information, pages and applications available from system 840 over network 882.

### Conclusion

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, if executed by a set of one or more processors, are configurable to cause a system to perform operations comprising:
responsive to user input received via a low code editor that provides a graphical user interface (GUI) with a first area that provides a visual representation of content the user is building, generating a context;
responsive to the generating the context, automatically interacting during a first stage with at least one of a set of one or more artificial intelligence (AI) models to identify a property of a part of a data instance from which the visual representation is rendered, wherein the user input is relative to the GUI of the low code editor and not the data itself, wherein the visual representation includes a plurality of components, wherein the data instance includes respective parts from which respective ones of the plurality of components are rendered, wherein the respective parts include a respective set of one or more properties that each has a respective value;
responsive to the automatically interacting during the first stage identifying one of the properties as a currently identified property, automatically interacting during a second stage with at least one of the set of AI models to generate a new value for the currently identified property;
updating the data instance to reflect the new value for the currently identified property; and
causing the visual representation to be updated based on the updating.

2. The non-transitory machine-readable storage medium of claim 1, wherein the user input includes natural language text expressing a request to modify the visual representation.

3. The non-transitory machine-readable storage medium of claim 1, wherein the automatically interacting during the first stage comprises:
generating a first prompt based on the context, the data instance from which the visual representation is rendered, and a schema instance with which the data instance complies; and
responsive to submitting the first prompt to at least one of the set of AI models, receiving a first response with at least a first set of one or more identifiers that identifies the currently identified property and the respective one of the parts that includes the currently identified property.

4. The non-transitory machine-readable storage medium of claim 3, wherein the automatically interacting during the second stage comprises:
generating a second prompt based on the first response, the data instance, the schema instance, and the context; and
responsive to submitting the second prompt to at least one of the set of AI models, receiving a second response with the new value.

5. The non-transitory machine-readable storage medium of claim 3, wherein the generating the first prompt comprises:
generating a third prompt based on the context;
responsive to submitting the third prompt to at least one of the set of AI models, receiving a third response that identifies one of a plurality of intents as a currently selected intent; and
filtering, based on the currently selected intent, at least one of the properties from the data instance to generate a reduced version of the data instance, wherein the first prompt is based on the reduced version of the data instance rather than all data in the data instance.

6. The non-transitory machine-readable storage medium of claim 5, wherein each of the plurality of components is of one of a plurality of component types, wherein the schema instance includes respective schemas for respective ones of the plurality of component types, wherein the respective parts of the data instance identify corresponding schemas in the schema instance according to the plurality of component types of the rendered components, and wherein the generating the first prompt further comprises:
generating an annotated version of the reduced version of the data instance, wherein the generating the annotated version includes,
annotating those of the properties that remain in the reduced version of the data instance with respective identifiers; and
annotating the respective parts of the reduced version of the data instance with information from the corresponding schemas in the schema instance, wherein the first prompt includes the annotated version of the reduced version of the data instance.

7. The non-transitory machine-readable storage medium of claim 1, wherein the automatically interacting during the second stage comprises:
generating a second prompt based on the currently identified property, the data instance, a schema instance, and the context; and
responsive to submitting the second prompt to at least one of the set of AI models, receiving a second response with the new value.

8. The non-transitory machine-readable storage medium of claim 7, wherein each of the plurality of components is of one of a plurality of component types, wherein the schema instance includes respective schemas for respective ones of the plurality of component types, wherein the respective parts of the data instance identify corresponding schemas in the schema instance according to the plurality of component types of the rendered components, wherein each of the schemas include a set of one or more sub-schemas, where each of the sub-schemas is for one of a plurality of property types, wherein each of the properties in the data instance is one of the plurality property types for which there is one of the sub-schemas, and wherein the generating the second prompt comprises:
accessing information from the sub-schema for the property type of the currently identified property; and
accessing the value of the currently identified property, wherein the second prompt includes the value of the currently identified property, the accessed information from the sub-schema, and information from the data instance regarding the currently identified property.

9. The non-transitory machine-readable storage medium of claim 8, wherein the second prompt includes data from the context, wherein the data indicates at least one of a current selection, a tone, an identity, a purpose, a language, or any combination thereof.

10. The non-transitory machine-readable storage medium of claim 9, wherein the data indicates the tone using natural language text that identifies one of a plurality of styles of expression, wherein the data indicates the identity using natural language text that describes an entity, and wherein the data indicates the purpose using natural language text that describes the purpose for building the visual representation.

11. A method implemented by a system including one or more electronic devices, the method comprising:
responsive to user input received via a low code editor that provides a graphical user interface (GUI) with a first area that provides a visual representation of content the user is building, generating a context;
responsive to the generating the context, automatically interacting during a first stage with at least one of a set of one or more artificial intelligence (AI) models to identify a property of a part of a data instance from which the visual representation is rendered, wherein the user input is relative to the GUI of the low code editor and not the data itself, wherein the visual representation includes a plurality of components, wherein the data instance includes respective parts from which respective ones of the plurality of components are rendered, wherein the respective parts include a respective set of one or more properties that each has a respective value;
responsive to the automatically interacting during the first stage identifying one of the properties as a currently identified property, automatically interacting during a second stage with at least one of the set of AI models to generate a new value for the currently identified property;
updating the data instance to reflect the new value for the currently identified property; and
causing the visual representation to be updated based on the updating.

12. The method of claim 11, wherein the user input includes natural language text expressing a request to modify the visual representation.

13. The method of claim 11, wherein the automatically interacting during the first stage comprises:
generating a first prompt based on the context, the data instance from which the visual representation is rendered, and a schema instance with which the data instance complies; and
responsive to submitting the first prompt to at least one of the set of AI models, receiving a first response with at least a first set of one or more identifiers that identifies the currently identified property and the respective one of the parts that includes the currently identified property.

14. The method of claim 13, wherein the automatically interacting during the second stage comprises:
generating a second prompt based on the first response, the data instance, the schema instance, and the context; and
responsive to submitting the second prompt to at least one of the set of AI models, receiving a second response with the new value.

15. The method of claim 13, wherein the generating the first prompt comprises:
generating a third prompt based on the context;
responsive to submitting the third prompt to at least one of the set of AI models, receiving a third response that identifies one of a plurality of intents as a currently selected intent; and
filtering, based on the currently selected intent, at least one of the properties from the data instance to generate a reduced version of the data instance, wherein the first prompt is based on the reduced version of the data instance rather than all data in the data instance.

16. The method of claim 15, wherein each of the plurality of components is of one of a plurality of component types, wherein the schema instance includes respective schemas for respective ones of the plurality of component types, wherein the respective parts of the data instance identify corresponding schemas in the schema instance according to the plurality of component types of the rendered components, and wherein the generating the first prompt further comprises:
generating an annotated version of the reduced version of the data instance, wherein the generating the annotated version includes,
annotating those of the properties that remain in the reduced version of the data instance with respective identifiers; and
annotating the respective parts of the reduced version of the data instance with information from the corresponding schemas in the schema instance, wherein the first prompt includes the annotated version of the reduced version of the data instance.

17. The method of claim 11, wherein the automatically interacting during the second stage comprises:
generating a second prompt based on the currently identified property, the data instance, a schema instance, and the context; and
responsive to submitting the second prompt to at least one of the set of AI models, receiving a second response with the new value.

18. The method of claim 17, wherein each of the plurality of components is of one of a plurality of component types, wherein the schema instance includes respective schemas for respective ones of the plurality of component types, wherein the respective parts of the data instance identify corresponding schemas in the schema instance according to the plurality of component types of the rendered components, wherein each of the schemas include a set of one or more sub-schemas, where each of the sub-schemas is for one of a plurality of property types, wherein each of the properties in the data instance is one of the plurality property types for which there is one of the sub-schemas, and wherein the generating the second prompt comprises:
accessing information from the sub-schema for the property type of the currently identified property; and
accessing the value of the currently identified property, wherein the second prompt includes the value of the currently identified property, the accessed information from the sub-schema, and information from the data instance regarding the currently identified property.

19. The method of claim 18, wherein the second prompt includes data from the context, wherein the data indicates at least one of a current selection, a tone, an identity, a purpose, a language, or any combination thereof.

20. The method of claim 19, wherein the data indicates the tone using natural language text that identifies one of a plurality of styles of expression, wherein the data indicates the identity using natural language text that describes an entity, and wherein the data indicates the purpose using natural language text that describes the purpose for building the visual representation.
